(19) United States
(12) Patent Application Publication
(10) Pub. No.: US 2006/0011141 A1
(43) Pub. Date: Jan. 19, 2006

(54) Feed hopper

(76) Inventors: Charles R. Bird, Milford, IN (US); Lionel L. Kreger, Warsaw, IN (US); Theodore J. Cole, Milford, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/892,840

(22) Filed: Jul. 16, 2004

(51) Int. Cl. A01K 39/01

(52) U.S. Cl. 119/57.4

(57) ABSTRACT

A poultry floor feeding system is provided which includes a feeder line, a hopper boot, a feed hopper, a mounting collar, and a securing member. The feeder line conveys feed to feeders located at spaced locations thereon. The hopper boot is located on the feeder line. The feed hopper supplies feed to the feeder line and has a body portion which terminates in a discharge port at a lower end thereof. The mounting collar is operatively associated with the discharge port of the feed hopper for connecting the feed hopper to the hopper boot on the feeder line. The securing member releasably secures the mounting collar to the feed hopper such that the feed hopper can be easily removed from and replaced onto the feeder line for cleaning or repair.

### BACKGROUND OF THE INVENTION

The present invention relates to a poultry floor feeding system. More specifically, the present invention relates to a feed hopper for supplying feed to a feeder line and means for mounting the feed hopper such that the feed hopper can be easily removed from and replaced onto the feeder line for cleaning or repair.

Poultry floor feeding systems have been in use in poultry houses for many years in order to provide feed from a storage bin outside of the poultry house and into the individual feeders provided within the poultry house. One part of these poultry feeding systems, namely the steel feed hopper, has been virtually unchanged since the mid-1960's, even though the steel feed hopper is difficult to remove from the poultry feeding systems when cleaning is required or desired, and even though the steel feed hopper can create feeder suspension problems if it is not reinstalled properly. Also, the initial assembly of the steel feed hopper is time consuming for the installer.

Therefore, an improved poultry floor feeding system is needed. The present invention provides such a system. Features and advantages of the present invention will become apparent upon a reading of the attached specification, in combination with a study of the drawings.

### OBJECTS AND SUMMARY OF THE INVENTION

A primary object of the invention is to provide a poultry floor feeding system which is easier to install for an installer than poultry floor feeding systems of the prior art.

Another primary object of the invention is to provide a poultry floor feeding system which allows for the feed hopper to be easily removed and reinstalled by a producer.

Yet another primary object of the invention is to provide a poultry floor feeding system which is at least partially formed of plastic such that it will be lighter in weight to handle.

Still another primary object of the invention is to provide a poultry floor feeding system which is at least partially formed of a corrosion resistant material such that it will not rust.

An object of the invention is to provide a poultry floor feeding system which eases the removal of parts thereof for clean out.

Another object of the invention is to provide a poultry floor feeding system which enhances feed flow.

Yet another object of the invention is to provide a poultry floor feeding system which utilizes a suspension system.

Still another object of the invention is to provide a poultry floor feeding system which is lower in cost to produce in comparison to prior art poultry floor feeding systems.

Another object of the invention is to provide a poultry floor feeding system which can be easily shipped and stored.

Briefly, and in accordance with the foregoing, a poultry floor feeding system is provided including a feeder line for conveying feed to feeders located at spaced locations thereon, a hopper boot located on the feeder line, a feed hopper for supplying feed to the feeder line, the feed hopper having a body portion which terminates in a discharge port at a lower end thereof, a mounting collar operatively associated with the discharge port of the feed hopper for connecting the feed hopper to the hopper boot on the feeder line, and securing means for releasably securing the mounting collar to the feed hopper such that the feed hopper can be easily removed from and replaced onto the feeder line for cleaning or repair.

### BRIEF DESCRIPTION OF THE DRAWINGS

The features of the present invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 is a perspective view showing a poultry house in which is installed the poultry floor feeding system of the present invention;

FIG. 2 is a perspective view of a portion of the poultry floor feeding system of the present invention;

FIG. 3 is an exploded perspective view of the portion of the poultry floor feeding system as illustrated in FIG. 2;

FIG. 4 is a front elevational view of the portion of the poultry floor feeding system as illustrated in FIG. 2;

FIG. 5 is a side elevational view of the portion of the poultry floor feeding system as illustrated in FIG. 2;

FIG. 6A is a perspective view of the mounting collar of the poultry floor feeding system of the present invention;

FIG. 6B is a top elevational view of the mounting collar as illustrated in FIG. 6A;

FIG. 6C is a bottom elevational view of the mounting collar as illustrated in FIG. 6A;

FIG. 6D is front elevational view of the mounting collar as illustrated in FIG. 6A;

FIG. 6E is a side elevational view of the mounting collar as illustrated in FIG. 6A;

FIG. 7A is a side elevational view of a first half of a funnel portion of a feed hopper of the poultry floor feeding system of the present invention;

FIG. 7B is a front elevational view of the first half of the funnel portion as illustrated in FIG. 7A;

FIG. 7C is a front elevational view of a second half of the funnel portion of the feed hopper of the poultry floor feeding system of the present invention; and

FIG. 8 is a partial perspective view of a header drop tube secured to the feed hopper of the poultry floor feeding system of the present invention.

### DETAILED DESCRIPTION OF THE ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated and described herein.

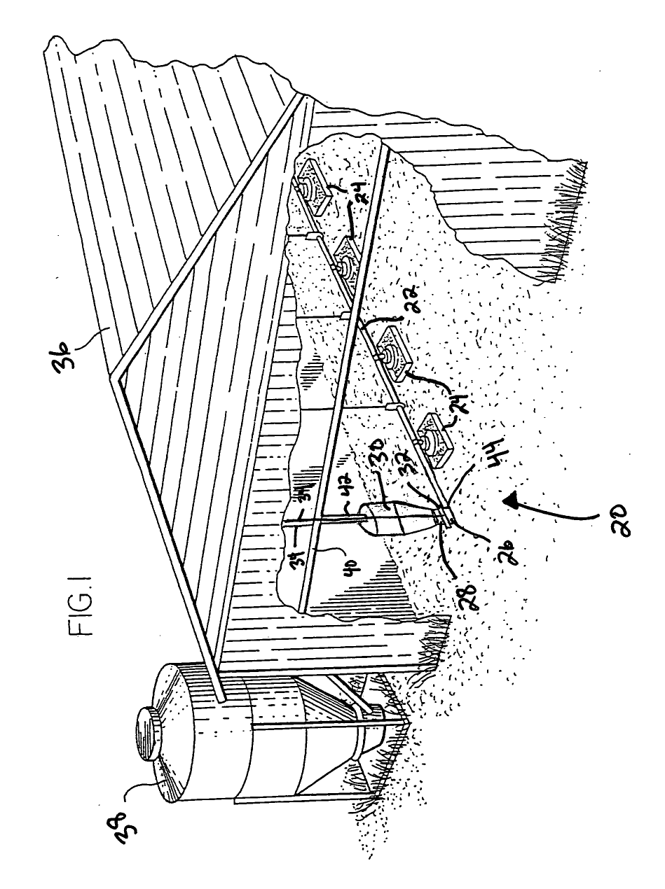

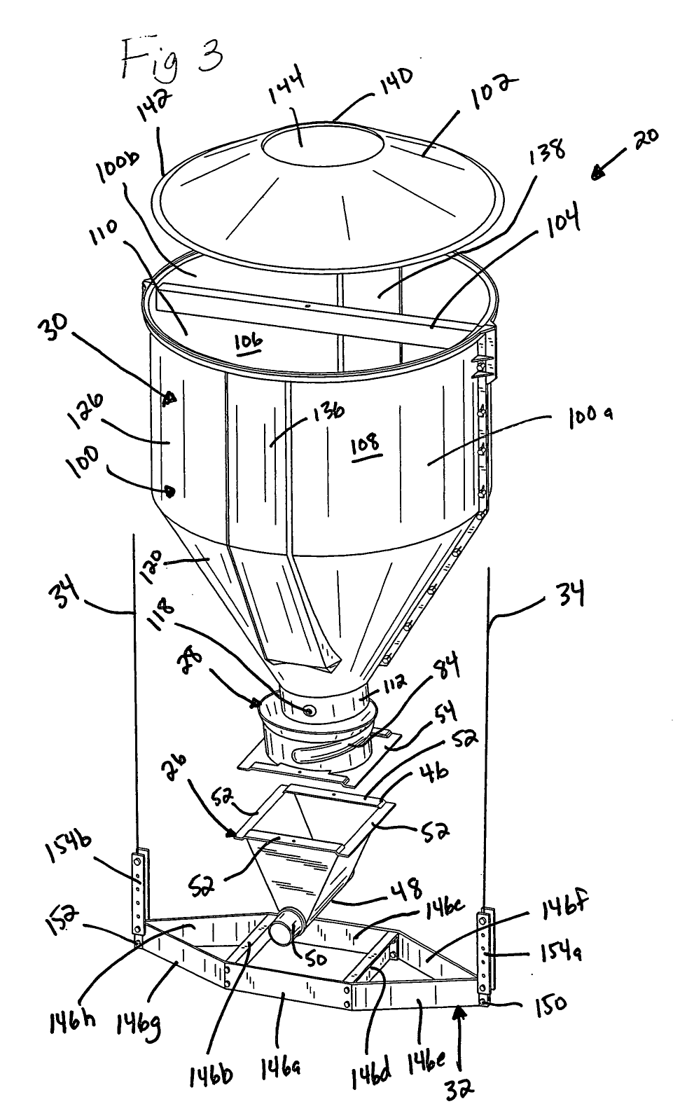

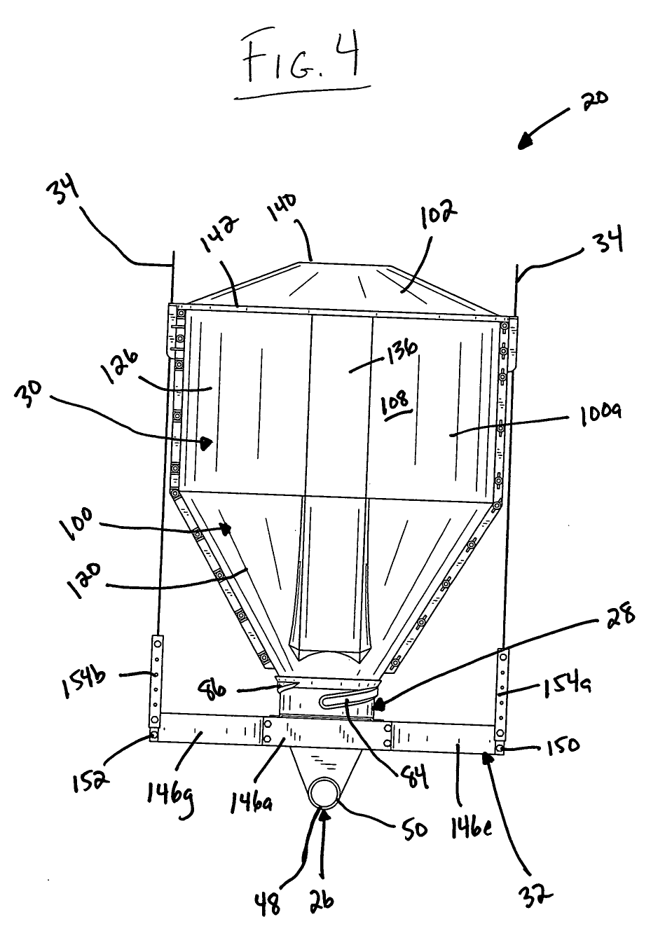

A poultry floor feeding system 20 of the present invention is illustrated in FIGS. 1-5. The poultry floor feeding system 20 generally includes a feeder line 22, a plurality of feeders 24, a hopper boot 26, a mounting collar 28, a feed hopper 30, a suspension member 32, and suspension cables 34. The hopper boot 26, the mounting collar 28, and the feed hopper 30 are all preferably made of a corrosion resistant material such that these parts of the poultry floor feeding system 20 will not rust. The hopper boot 26, the mounting collar 28, and the feed hopper 30 are all also preferably made of plastic such that the poultry floor feeding system 20 is lighter in weight, making it easier to handle; by forming the hopper boot 26, the mounting collar 28 and the feed hopper 30 of plastic, these parts will weigh approximately ten to fifteen pounds whereas similar parts in prior poultry floor feeding systems could weigh upward of a few hundred pounds. The poultry floor feeding system 20 is typically provided in a poultry house 36, such as the poultry house 36 illustrated in FIG. 1. The size and positioning of the poultry floor feeding system 20 may differ from that as illustrated in FIG. 1 depending on numerous factors. A feed storage bin 38 is typically located outside the poultry house 36 and provides feed to the poultry floor feeding system 20 by a header conveyor 40 and a header drop tube 42 by a manner which is known in the art and, therefore, will not be discussed in detail herein.

The feeder line 22 typically extends along a length of the poultry house 36 proximate to the floor of the poultry house 36. The plurality of feeders 24 are operatively associated with the feeder line 22 and are spaced from one another. Each of the plurality of feeders 24 are configured such that they can receive feed from the feeder line 22 such that they can present the feed to the poultry within the poultry house 36. It is to be understood that other types of feeders 24 can be used in the poultry floor feeding system 20 than those that are illustrated in FIG. 1.

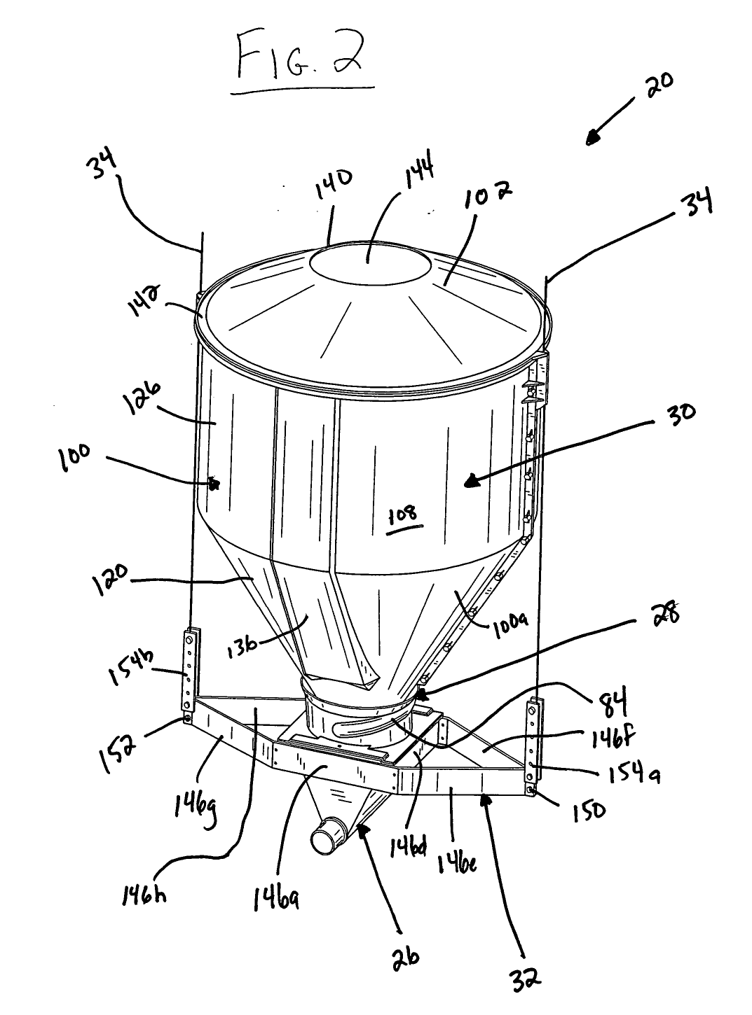

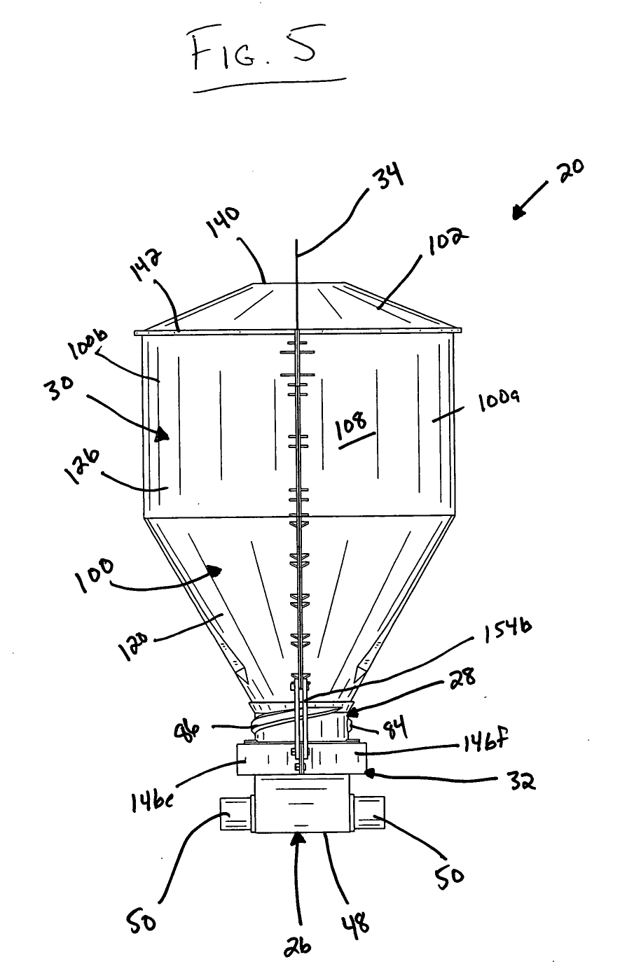

The feeder line 22 as illustrated in FIG. 1 is attached at a first end 44 thereof to a hopper boot 26. As best illustrated in FIGS. 2-5, the hopper boot 26 is preferably formed in a funnel-like configuration such that a top end 46 thereof is larger than a bottom end 48 thereof, in order to facilitate the flow of feed from the top end 46 of the hopper boot 26 to the bottom end 48 of the hopper boot 26. A tube member 50 is associated with the bottom end 48 of the hopper boot 26. The tube member 50 is configured to be operatively associated with the feeder line 22 such that feed in the hopper boot 26 will move through the tube member 50 and into the feeder line 22. It is to be understood that the feeder line 22 may be attached at a middle portion of the feeder line 22 so long as the hopper boot 26 is provided with a pair of tube members 50, each extending from opposite sides of the bottom end 48 of the hopper boot 26, as illustrated in FIG. 5.

The top end 46 of the hopper boot 26 is preferably rectangular and is open such that feed can flow into the hopper boot 26. The top end 46 of the hopper boot 26 is provided with flanges 52 extending therefrom. The flanges 52 are provided for supporting the mounting collar 28 and for securing the mounting collar 28 to the hopper boot 26. The mounting collar 28 and the hopper boot 26 are preferably secured to one another by appropriate fastening means, such as a bolt or a rivet. It is to be understood that the hopper boot 26 can have other configurations than those as illustrated and described.

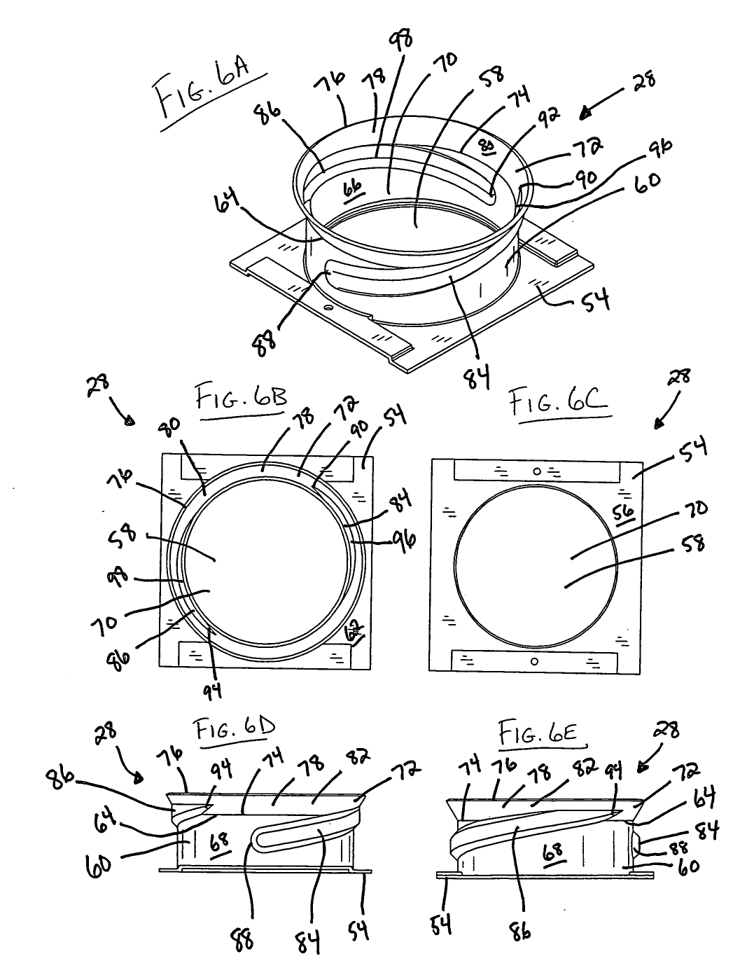

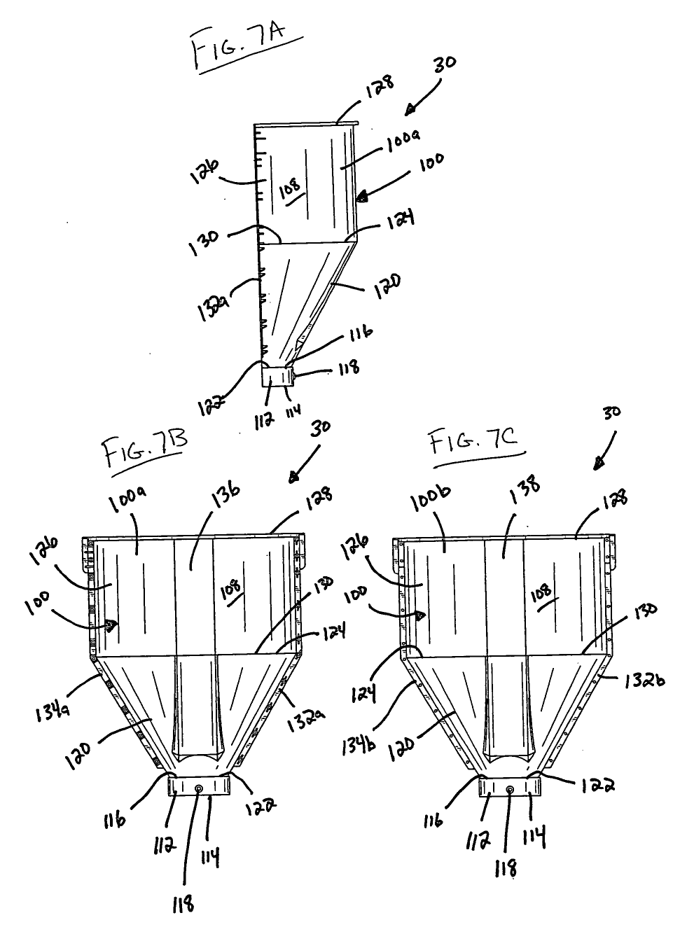

The mounting collar 28 is best illustrated in FIGS. 6A-6E. The mounting collar 28 includes a base portion 54. The base portion 54 is preferably rectangular such that a bottom surface 56 thereof is configured to be positioned on the flanges 52 of the top end 46 of the hopper boot 26. The base portion 54 is further configured to be secured to the flanges 52 of the top end 46 of the hopper boot 26 by the appropriate fastening means as disclosed hereinabove. The base portion 54 also has an aperture 58 provided therethrough which is in communication with the interior of the hopper boot 26, such that feed can flow through the aperture 58 of the base portion 54 and into the hopper boot 26. The aperture 58 is preferably circular.

The mounting collar 28 further includes a right circular cylinder member 60 which extends upwardly from the top surface 62 of the base portion 54 of the mounting collar 28 to a top edge 64 thereof. The right circular cylinder member 60 is positioned around the aperture 58 of the base portion 54. The right circular cylinder member 60 defines an inner surface 66 and an outer surface 68 and defines an aperture 70 which is in communication with the aperture 58 of the base portion 54.

The mounting collar 28 further includes a hollow frustum member 72 defining a bottom circular edge 74, a top circular edge 76, and an angled wall 78 which connects the bottom circular edge 74 to the top circular edge 76. The angled wall 78 defines an inner surface 80 and an outer surface 82 of the frustum member 72 and is preferably angled at about a sixty degree angle. The wall 78 is angled because the bottom circular edge 74 has a diameter which is less than a diameter of the top circular edge 76. The diameter of the bottom circular edge 74 is preferably identical to a diameter of the top edge 64 of the right circular cylinder member 60 such that the bottom circular edge 74 is positioned on the top edge 64 of the right circular cylinder member 60. As the frustum member 72 is hollow, the frustum member 72 defines an aperture 84 therethrough which is in communication with the aperture 70 of the right circular cylinder member 60.

The mounting collar 28 further includes a pair of helical portions 84, 86. A first end 88 of helical portion 84 is provided approximately equidistant between the top surface 62 of the base portion 54 and the top edge 64 of the right circular cylinder member 60. The helical member 84 then curves around the mounting collar 28, preferably in a counter-clockwise direction and ends at a second end 90 thereof, which is provided approximately equidistant between the bottom edge 74 and the top edge 76 of the frustum member 72. The helical member 84 extends around the mounting collar 28 preferably less than 180 degrees. Likewise, a first end 92 of helical portion 86 is provided approximately equidistant between the top surface 62 of the base portion 54 and the top edge 64 of the right circular cylinder member 60. The helical member 86 then curves around the mounting collar 28, preferably in a counter-clockwise direction and ends at a second end 94 thereof, which is provided approximately equidistant between the bottom edge 74 and the top edge 76 of the frustum member 72. The helical member 86 extends around the mounting collar 28 preferably less than 180 degrees. Preferably, the first ends 88, 92 of the helical members 84, 86, respectively, are positioned 180 degrees apart from one another on the mounting collar 28.

The helical portions or mating threads 84, 86 define recesses 96, 98 in the inner surfaces 66, 80 of the right circular cylinder member 60 and the frustum member 72, respectively, such that the helical portions 84, 86 protrude from the outer surfaces 68, 82 of the right circular cylinder member 60 and the frustum member 72, respectively.

The base portion 54, the right circular cylinder member 60 and the frustum member 72 are all preferably integrally formed, but may be formed of separate pieces if desired.

The feed hopper 30 is formed of a funnel portion 100, a cover member 102, and a cross member 104. The funnel portion 100 defines an inner surface 106 and an outer surface 108 and defines an aperture 110 therethrough. The funnel portion 100 includes a bottom right circular cylinder member 112 which has a bottom edge 114 and a top edge 116. The bottom right circular cylinder member 112 acts as the discharge port of the feed hopper 30. The bottom right circular cylinder member 112 has a pair of protrusions 118 which extend outwardly from the outer surface 108 of the funnel portion 100 which are positioned approximately 180 degrees apart from one another. The protrusions 118 are sized to mesh into the recesses 96, 98 of the helical portions or mating threads 84, 86 of the mounting collar 28 such that the protrusions 118 can be moved within the recesses 96, 98 of the helical portions 84, 86 in order to secure the bottom right circular cylinder member 112 to the mounting collar 28 or in order to release the bottom right circular cylinder member 112 from the mounting collar 28. The helical portions or mating threads 84, 86 and the protrusions 118 work together for releasably securing the feed hopper 30 to the mounting collar 28. Of course, it is to be understood that other items could be used to releasably secure the feed hopper 30 to the mounting collar 28, such as, for instance a cotter pin.

The funnel portion 100 includes a frustum member 120 which has a bottom circular edge 122 and a top circular edge 124. The bottom edge 122 has a diameter which is less than a diameter of the top circular edge 124 such that the frustum member 120 is angled upwardly and outwardly from the bottom edge 122 to the top edge 124, preferably at an angle of about sixty degrees as such an angle has been found to help promote the flow of feed therethrough. The bottom edge 122 of the frustum member 120 is positioned on the top edge 116 of the bottom right circular cylinder member 112. The frustum member 72 is configured such that it surrounds the frustum member 120 proximate to the bottom edge 122 thereof.

The funnel portion 100 includes a top right circular cylinder member 126 which has a top circular edge 128 and a bottom circular edge 130. The bottom edge 130 of the top right circular cylinder member 126 is positioned on the top edge 124 of the frustum member 120.

The funnel portion 100 is formed in two halves 100a, 100b which are secured to one another along flanges 132a, 132b, 134a, 134b which extend outwardly from the outer surface 108 of the funnel portion 100 by appropriate means, such as by bolts and nuts. Flange 132a is secured to flange 134b and flange 134a is secured to flange 132b. Because the funnel portion 100 is formed from two halves 100a, 100b, the flanges 132a, 134a are preferably positioned 180 degrees apart from one another, and the flanges 132b, 134b are preferably positioned 180 degrees apart from one another. The two halves 100a, 100b also allow for the funnel portion 100 to be easily shipped or stored as desired, as they are configured to be stackable upon one another.

The frustum member 120 and the top right circular cylinder member 126 may also be provided with a pair of raised portions 136, 138 along the outer surface 108 thereof for strengthening purposes. The raised portions 136, 138 are preferably positioned 180 degrees apart from one another and are preferably positioned 90 degrees apart from the flanges 132a, 132b, 134a, 134b.

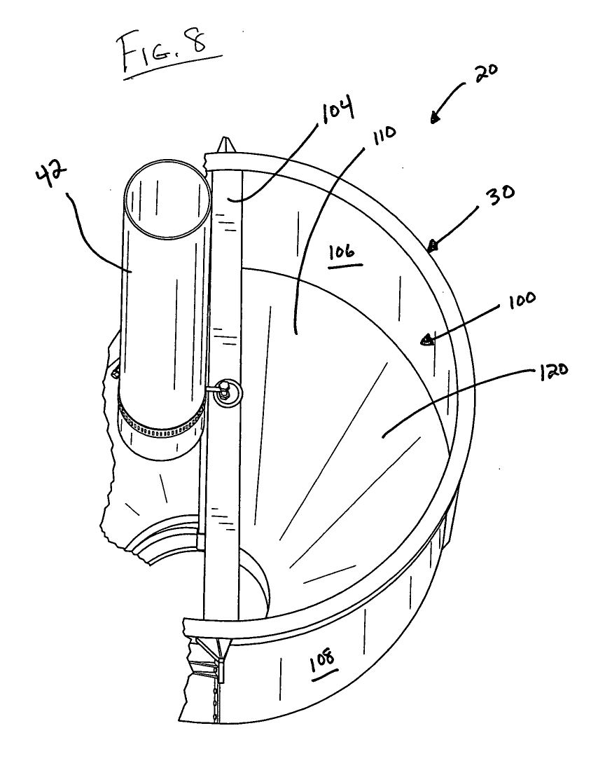

The feed hopper 30 also preferably has a cross member 104 which spans the aperture 110 and is connected to the inner surface 106 of the funnel member 100 proximate to the top edge 128 of the top right circular cylinder member 126 by appropriate means in order to stabilize the funnel member 100 and in order to help the funnel member 100 retain its shape. The header drop tube 42 may also be secured to the cross member 104 by appropriate means, such as that illustrated in FIG. 8, if desired.

The cover member 102 is preferably in the form of a frustum or a truncated cone such that it has a top edge 140 which has a diameter which is smaller than a diameter of a bottom circular edge 142 thereof. The cover member 102 is hollow such that an opening 144 is provided through the cover member 102 between the top edge 140 thereof. The bottom edge 142 is configured such that it can rest upon the top edge 128 of the top right circular cylinder member 126 of the funnel portion 100, thus covering the aperture 110 of the funnel portion 100, except for where the opening 144 of the cover member 102 provides access to the aperture 110. The cover member 102 may be secured to the funnel member 100 by appropriate means. The header drop tube 42 may be inserted through the opening 144 of the cover member 102 in order to provide feed into the aperture 110 of the funnel member 100. The feed in the aperture 110 of the funnel member 100 would then flow into the hopper boot 26, through the feeder line 22 and into the plurality of feeders 24 in order to provide feed to the poultry within the poultry house 36. The cylindrical and conical configuration of the funnel member 100 promotes easy flow of the feed through the funnel member 100.

The suspension member 32 includes first, second, third and fourth members 146a, 146b, 146c, 146d which are formed together in a square or rectangle-like configuration such that first member 146a is connected to second and fourth members 146b, 146d; such that second member 146b is connected to first and third members 146a, 146c; such that third member 146c is connected to second and fourth members 146b, 146d; and such that fourth member 146d is connected to first and third members 146a, 146c. The configuration of the first, second, third and fourth members 146a, 146b, 146c, 146d is such that the hopper boot 26 can be inserted therebetween and such that the flanges 52 of the hopper boot 26 rest on a top edge 148 of the suspension member 32, in order to support the hopper boot 26.

The suspension member 32 further includes a fifth and sixth member 146e, 146f. The fifth member 146e extends outwardly from the connection of the first and fourth members 146a, 146d and the sixth member 146f extends outwardly from the connection of the third and fourth members 146c, 146d such that the fifth and sixth members 146e, 146f are capable of connecting to one another at 150 by appropriate means, such as by a bolt and a nut. Likewise, the suspension member 32 further includes a seventh and eighth member 146g, 146h. The seventh member 146g extends outwardly from the connection of the first and second members 146a, 146b and the eighth member 146h extends outwardly from the connection of the second and third members 146b, 146c such that the seventh and eighth members 146g, 146h are capable of connecting to one another at 152 by appropriate means, such as by a bolt and a nut.

The suspension member 32 further includes first and second extension members 154a, 154b. Extension member 154a is secured at a lower end thereof to the connection 150 of the fifth and sixth members 146e, 146f by appropriate means. Extension member 154b is secured at a lower end thereof to the connection 152 of the seventh and eighth members 146g, 146h by appropriate means. Suspension cables 34 are secured at upper ends of the extension members 154a, 154b and extend upwardly to either the roof of the poultry house 36 or to trusses of the poultry house 36, or both. The suspension cables 34 suspend the poultry floor feeding system 20 from the poultry house 36 such that the poultry floor feeding system 20 does not come into contact with the floor of the poultry house 36. The suspension cables 34 are preferably stabilized between the extension members 154b and their securement to the poultry house 36 by releasably securing them to the funnel member 100 proximate to the top edge 128 of the top right circular cylinder member 126 along the outer surface 108 of the funnel member 100. The suspension cables 34 are preferably positioned between the flanges 132a, 134b; 132b, 134a and are snapped in therebetween as the flanges 132a, 134b; 132b, 134a preferably have some type of protrusion, such as a pin or a dimple, extending therefrom such that the suspension cables 34 must be forced past the protrusions to be secured. The suspension cables 34 can, of course, be removed from between the flanges 132a, 134b; 132b, 134a by supplying a force to the cables 34 to move them past the protrusions. The suspension cables 34 are preferably hung from the poultry house 36 at a distance which is less than where the suspension cables 34 are secured at the feed hopper 30. The suspension member 32 and the suspension cables 34 allow for the adjustment of the feeder line 22 at different distances above the feeding surface.

Thus, the poultry floor feeding system 20 provides a number of advantages over other similar systems of the prior art. The capability of the protrusions 118 on the feed hopper 30 to be positioned in or mate with the recesses 96, 98 of the helical portions or mating threads 84, 86 of the mounting collar 28 allow for the feed hopper 30 to be easily secured or engaged to the mounting collar 28 by merely twisting or rotating the feed hopper 30 relative to the mounting collar 28 in a first direction. Thus, the protrusions 118 and the recesses 96, 98 of the helical portions or mating threads 84, 86 act as a securing member or securing means which secure the feed hopper 30 to the mounting collar 28. Likewise, the capability of the protrusions 118 on the feed hopper 30 to be positioned in or mate with the recesses 96, 98 of the helical portions or mating threads 84, 86 of the mounting collar 28 allow for the feed hopper 30 to be easily released or disengaged from the mounting collar 28 by merely twisting or rotating the feed hopper 30 relative to the mounting collar 28 in a second direction. Thus, a worker in the poultry house 36 can easily remove the feed hopper from the poultry floor feeding system 20 in order to facilitate cleaning or repair. Also, as the feed hopper 30, the mounting collar 28 and the hopper boot 26 are all preferably formed of a corrosion resistant material, these pieces will not rust over time as will similar parts used in the poultry floor feeding systems of the prior art. The feed hopper 30, the mounting collar 28 and the hopper boot 26 are all also preferably formed of plastic such that it is easy to pick up or move any one of these pieces as they are formed of a lightweight material. The configuration of the poultry floor feeding system 20, namely the mounting collar 28 and the feed hopper 30, also allows for the feed hopper 30 to be released from, or secured to, the mounting collar 28 by hand, without the need for tools. As the funnel portion 100 of the feed hopper 30 is formed in two halves, the funnel portion 100 is formed in pieces which are stackable and, thus, facilitate shipment and storage. Finally, the poultry floor feeding system 20 is configured such that it can be adjustably suspended from the roof or trusses of the poultry house 36. The configuration of the poultry floor feeding system 20 also allows for the feed hopper 30 to be removed and reinstalled without effecting the suspension of the system 20.

While a preferred embodiment of the present invention is shown and described, it is envisioned that those skilled in the art may devise various modifications of the present invention without departing from the spirit and scope of the appended claims.

The invention is claimed as follows:

1. A poultry floor feeding system comprising:
a feeder line for conveying feed to feeders located at spaced locations therealong;
a hopper boot connected to said feeder line;
a feed hopper for supplying feed to said feeder line, said feed hopper having a body portion which terminates in a discharge port at a lower end thereof;
a mounting collar operatively associated with said discharge port of said feed hopper for connecting said feed hopper to said hopper boot on said feeder line; and
means for releasably securing said mounting collar to said feed hopper such that said feed hopper can be easily removed from and replaced onto said feeder line for cleaning or repair.

2. A poultry floor feeding system as defined in claim 1, wherein said releasably securing means comprises a protrusion located on said body portion of said feed hopper near said discharge port and a mating thread formed on said mounting collar which can be rotatably engaged and disengaged from one another.

3. A poultry feeding system as defined in claim 1, wherein said body portion of said feed hopper is formed from two stackable pieces in order to facilitate shipment and storage.

4. A poultry feeding system as defined in claim 1, wherein said body portion of said feed hopper is made of plastic.

5. A poultry feeding system as defined in claim 1, wherein said mounting collar is made of plastic.

6. A poultry feeding system as defined in claim 1, further comprising a cover member operatively associated with an open top of the body portion of the feed hopper.

7. A poultry feeding system as defined in claim 1, wherein the body portion of the feed hopper includes an upper cylindrical portion and lower conical portion to facilitate feed flow therein.

8. A poultry feeding system as defined in claim 1, further comprising means for suspending the feeder line at adjustable distances above a feeding surface.

9. A poultry feeding system as defined in claim 8, wherein the feed hopper can be removed and reinstalled without effecting the means for suspending the feeder line.

10. A poultry feeding system as defined in claim 1, wherein the body portion of the feed hopper is made of a corrosion resistant material.

11. A feed hopper and mounting collar combination for use in a poultry floor feeding system having a feeder line which includes a plurality of feeders and a hopper boot, said combination comprising:
a feed hopper having a body portion;
a mounting collar which is operatively connected to the hopper boot; and
means for releasably securing said mounting collar to said feed hopper such that said feed hopper can be easily removed for cleaning or repair and quickly reinstalled onto the feeder line.

12. A combination as defined in claim 11, wherein said releasably securing means comprises a protrusion located on said feed hopper and a mating thread formed on said mounting collar which can be rotatably engaged and disengaged from one another.

13. A combination as defined in claim 11, wherein said feed hopper is formed from two stackable pieces in order to facilitate shipment and storage.

14. A combination as defined in claim 11, wherein said body portion of said feed hopper includes an upper cylindrical portion and lower conical portion to facilitate feed flow therein.

15. A combination as defined in claim 11, wherein said body portion of said feed hopper is made of plastic.

16. A combination as defined in claim 11, wherein said body portion of said feed hopper is made of a corrosion resistant material.

17. A combination as defined in claim 11, wherein the poultry floor feeding system is suspended above the ground and wherein said feed hopper can be removed and reinstalled from said mounting collar without effecting the suspension of the feeding system.

18. A combination as defined in claim 11, wherein said feed hopper includes a cover member for selectively placement over an open top of said feed hopper.

19. A combination as defined in claim 11, wherein said mounting collar is formed from plastic.
